(19) United States
(12) Patent Application Publication
(10) Pub. No.: US 2026/0012247 A1
(43) Pub. Date: Jan. 8, 2026

(54) A METHOD FOR CONTROLLING A COVERAGE ENHANCING DEVICE, A COVERAGE ENHANCING DEVICE CONTROLLING NODE, AND A COVERAGE ENHANCING DEVICE

(71) Applicant: Sony Group Corporation, Tokyo (JP)

(72) Inventors: Kun ZHAO, Malmö (SE); Jose FLORDELIS, Lund (SE); Olof ZANDER, Södra Sandby (SE); Fredrik RUSEK, Eslöv (SE); Erik BENGTSSON, Eslöv (SE)

(21) Appl. No.: 18/992,136

(22) PCT Filed: Jun. 29, 2023
(86) PCT No.: PCT/EP2023/067795

§ 371 Date: Jan. 7, 2025

(30) Foreign Application Priority Data
Jul. 19, 2022 (SE) 2250922-8

(51) Int. Cl. H04B 7/155; H04B 7/0408; H04W 72/044; H04W 72/0453

(52) U.S. Cl. CPC H04B 7/15528; H04B 7/0408; H04W 72/0453; H04W 72/046

(57) ABSTRACT

A method is disclosed, performed by a coverage enhancing device (CED) controlling node, for controlling a CED. The method comprises transmitting, to the CED, a configuration message, the configuration message comprising a frequency width parameter. The frequency width parameter is indicative of a frequency width adjustment to be applied by the CED to a signal retransmitted by the CED.

The present disclosure pertains to the field of wireless communications. The present disclosure relates to a method for controlling a coverage enhancing device (CED), a related CED controlling node and a CED.

### BACKGROUND

Coverage enhancing devices (CEDs), such as smart repeaters and reflective intelligent surfaces (RISs), can provide coverage enhancement for devices using 5G and beyond. Coverage enhancing devices can make use of array gain when reflecting, such as retransmitting signals from a wireless device to a base station, and/or from a base station to a wireless device. CEDs can be used to improve signal coverage, for example at hard-to-reach locations, or transitions from outdoors to indoors. Certain coverage enhancing devices can be reconfigurable, such as having the ability to choose a phase shift per coverage enhancing unit cell, such as per antenna element. By applying a phase shift, such as by changing the phase, a change of direction of an outgoing signal can be applied. The phase shift, such as phase angles, can be configured to obtain desired incoming and/or outgoing angles of a signal. Typically, the CED retransmits the signal received from the transmitter node in order to reach receiver nodes located out of coverage of the transmitter node using the frequency bandwidth of the signal received by the CED from the transmitter node.

However, a significant problem is that the spectrum for the retransmission may be restricted, since the transmitter node may communicate with a plurality of receiver nodes which share the available bandwidth at the transmitter node. This may, for example, be the case when the transmitter node is a base station serving a plurality of wireless devices. This may lead to poor robustness, latency and/or throughput of the transmission.

### SUMMARY

Accordingly, there is a need for devices and methods for controlling a coverage enhancing device, which may mitigate, alleviate or address the shortcomings existing and may provide an improved diversity order of the signal retransmitted by the CED.

A method is disclosed, performed by a coverage enhancing device (CED) controlling node, for controlling a CED. The method comprises transmitting, to the CED, a configuration message, the configuration message comprising a frequency width parameter. The frequency width parameter is indicative of a frequency width adjustment to be applied by the CED to a signal retransmitted by the CED.

Further, a CED controlling node is provided, the CED controlling node comprising memory circuitry, processor circuitry, and a wireless interface, wherein the CED controlling node is configured to perform any of the methods disclosed herein and relating to the CED controlling node.

It is an advantage of the present disclosure that the CED controlling node can configure the CED to retransmit a signal over a different frequency bandwidth than the frequency bandwidth in which the signal was received by the CED. The CED controlling node can, for example, configure the CED to retransmit a signal from a radio network node to a WD at a wider frequency bandwidth than the frequency bandwidth in which the signal was transmitted from the radio network node to the CED. Thereby, the CED can transmit the signal using a narrow frequency bandwidth between the CED and the radio network node where bandwidth resources are typically scarce since the radio network node typically serves a plurality of WDs, while the diversity of the signal can be improved by the CED spreading the transmitted signal over a wider frequency bandwidth between the CED and the WD where bandwidth resources are typically abundant since the WD typically only communicates with a single radio network node. The diversity of the signal can herein be seen as the wireless communication system's diversity order at the receiver, such as at a receiver node. In other words, increasing the diversity of the signal at the CED can be seen as the diversity order at the receiver node receiving the retransmitted signal from the CED being higher than the diversity order at the CED when receiving the signal from a transmitter node, such as from a source node of the originally transmitted signal. By improving the diversity, such as the frequency diversity, of the signal, the robustness of the signal can be improved, the latency can be reduced and/or the throughput can be increased. Applying and/or increasing diversity can herein be seen as increasing the frequency resources over which the signal is transmitted, such as widening the frequency bandwidth over which the signal is transmitted.

A method is disclosed, performed by a CED. The method may be a method for performing retransmission of a signal received by the CED. The method comprises receiving, from a CED controlling node, a configuration message. The configuration message comprises a frequency width parameter, the frequency width parameter being indicative of a frequency width adjustment to be applied by the CED to a signal retransmitted by the CED. The method comprises applying the frequency width adjustment to a signal received from a transmitter node. The method comprises transmitting, to a receiver node, the signal with the applied frequency width adjustment.

Further, a CED is provided, the CED comprising memory circuitry, processor circuitry, and a wireless interface, wherein the CED is configured to perform any of the methods disclosed herein and relating to the CED.

It is an advantage of the present disclosure that the CED can be configured by the CED controlling node to retransmit a signal over a different frequency bandwidth than the frequency bandwidth in which the signal was received by the CED. The CED can for example be configured to retransmit a signal from a radio network node to a WD at a wider frequency bandwidth than the frequency bandwidth in which the signal was transmitted from the radio network node to the CED. Thereby, the CED can transmit the signal using a narrow frequency bandwidth between the CED and the radio network node where bandwidth resources are typically scarce since the radio network node typically serves a plurality of WDs, while the diversity of the signal can be improved by spreading the transmitted signal over a wider frequency bandwidth between the CED and the WD where bandwidth resources are typically abundant since the WD typically only communicates with a single radio network node. By applying diversity to the signal, the robustness of the signal can be improved, the latency can be reduced and/or the throughput can be increased.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, an example CED, and an example wireless device according to this disclosure,

FIG. 2A is a diagram illustrating an example wireless communication system comprising a CED being configured to serve a first and a second WD according to this disclosure,

FIG. 2B is a diagram illustrating an example method for adjusting a frequency width of a retransmitted signal according to this disclosure,

FIG. 3A-3C are diagrams illustrating an example method for applying a frequency width adjustment according to the current disclosure,

FIG. 4A-4B are diagrams illustrating a respective broadening of a frequency width for a retransmitted signal according to this disclosure,

FIG. 5 is a flow-chart illustrating an example method, performed in a CED controlling node, for controlling the CED according to this disclosure,

FIG. 6 is a flow-chart illustrating an example method, performed in a CED, according to this disclosure,

FIG. 7 is a block diagram illustrating an example CED controlling node according to this disclosure, and

FIG. 8 is a block diagram illustrating an example CED according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

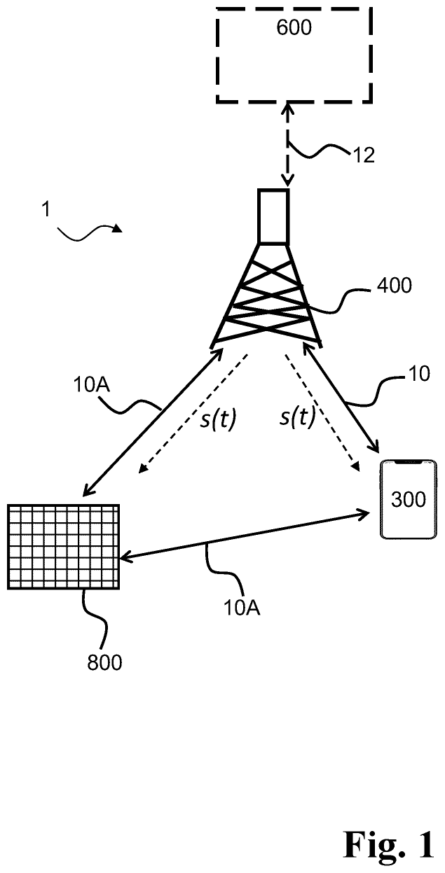

FIG. 1 is a diagram illustrating an example wireless communication system 1 according to this disclosure. The wireless communication system 1 comprises a wireless device 300, a network node 400 and a core network (CN) node 600.

As discussed in detail herein, the present disclosure relates to a wireless communication system 1 comprising a cellular system, for example, a 3GPP wireless communication system.

A network node disclosed herein refers to a radio access network (RAN) node operating in the radio access network, such as a base station, an evolved Node B, eNB, gNB in NR, and/or a transmission and reception point (TRP). In one or more examples, the RAN node is a functional unit which may be distributed in several physical units.

The CN node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more examples, the CN node is a functional unit which may be distributed in several physical units.

The wireless communication system 1 described herein may comprise one or more wireless devices 300, and/or one or more network nodes 400, such as one or more of a base station, an eNB, a gNB and an access point.

A wireless device 300 may refer to a mobile device and/or a user equipment (UE). The wireless device 300 may be configured to communicate with the network node 400 via a wireless link (or radio access link) 10.

The wireless communication system 1 may comprise a coverage enhancing device (CED) 800. The CED 800 may be one or more of a smart repeater, a reflective intelligent surface (RIS) and/or another wireless device (WD). The CED 800 may provide coverage enhancement for devices using 5G and beyond. The CED 800 may be configurable by the network node 400 and may be used to improve signal coverage in the wireless communication system 1. The CED 800 may be used to retransmit, such as forward, signals, such as data and/or control signals, between the network node 400 and the WD 300. The retransmission can be advantageous when the WD 300 is located at hard-to-reach locations, such as at a border of a coverage area of the network node 400 and/or when a direct link between the network node 400 and the WD 300 is obstructed. The CED 800 may comprise a plurality of antenna elements that can be configured with a respective phase shift. By controlling the phase shifts, such as jointly controlling the phase shifts, an incoming and/or outgoing angle of a signal received and/or transmitted by the CED 800 can be controlled and/or adapted. In one or more example methods, the angle of incoming and outgoing signals can be controlled by controlling the relative phase between antenna elements of the CED 800. The phase shift may be a capacitor-based phase shift and/or a true time delay line, such as a time domain shift, between antenna elements of the CED 800. The WD 300 may be configured to communicate with the network node 400 directly via the wireless link (or radio access link) 10 and/or via the CED 800 via wireless link 10A. The wireless link 10A may herein be referred to as a reflected, such as retransmitted, wireless link. The CED 800 may be controlled by one or more network nodes, such as the network node 400, or one or more wireless devices, such as the WD 300. The one or more network nodes or wireless devices controlling the CED 800 may herein be referred to as coverage enhancing device controlling nodes. In one or more example methods, the coverage enhancing device controlling node can be a CN node, such as the CN node 600 in FIG. 1. In one or more example methods, the coverage enhancing device controlling node can be a node in an external network that can access the CED 800, for example through the internet via a gateway function.

According to the current disclosure, the CED 800 can be configured, for example by a CED controlling node, to apply a frequency width adjustment to a signal retransmitted by the CED. The CED controlling node can be the WD 300 or the radio network node 400. A frequency width adjustment can herein be seen as an adjustment of the frequency width, such as a width of the frequency band, over which a signal or a duplication of the signal is transmitted.

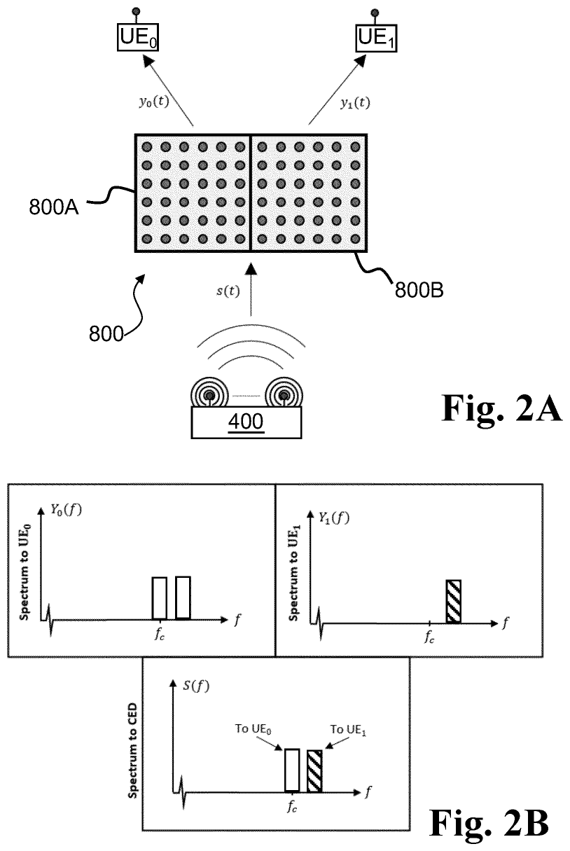

FIGS. 2A and 2B illustrate an example scenario in which the solution according to this disclosure is applied to a downlink signal from the radio network node 400 to a plurality of WDs. In the example scenario shown in FIGS. 2A and 2B, a CED 800 is configured to serve two WDs, such as a first WD, in FIGS. 2A and 2B referred to as UE₀, and a second WD, in FIGS. 2A and 2B referred to as UE₁. To do so, the CED 800 can be, abstractly, split into two sub-CEDs, such as sub-CEDs 800A and 800B. Abstractly split can herein be seen as a first subset of the set of antenna elements of the CED 800 being configured to serve a first WD, such as UE₀, and a second subset of the set of antenna elements of the CED 800 being configured to serve a second WD, such as UE₁. The first subset of antenna elements may be referred to as the first sub-CED 800A and the second subset of antenna elements may be referred to as the second sub-CED 800B. Assuming Line-of-Sight (LOS) conditions between the radio network node 400 and the CED 800, a single spatial layer per polarization can be transferred to the CED 800. In the example provided here, a single polarization is considered for simplicity. LOS conditions can herein be seen as conditions enabling the signal to travel in a direct path from a source, such as the radio network node, to a receiver, such as to the WD, without being diffracted, refracted, reflected, and/or absorbed by obstacles. In FIG. 2B, the bottom diagram shows the signals transmitted from the radio network node 400 to the CED, the upper left diagram shows the signal retransmitted from the CED 800 to the first WD, such as to UE₀, and the upper right diagram shows the signal retransmitted from the CED 800 to the second WD, such as UE₁.

To separate the signals, the signals can be separated in either time or frequency. In the example shown in the bottom diagram of FIG. 2B the signals transmitted by the radio network node 400 to the respective WDs are separated by frequency. Each sub-CED 800A, 800B can apply a frequency selection filter to isolate the signal of interest. In this example, the first sub-CED 800 spreads the signal across frequency, such as transmits the signal over a wider frequency band. In other words, the first sub-CED 800A may duplicate the signal transmitted to UE₀ and may transmit the duplicated signal at a different frequency than the corresponding signal received from the radio network node 400. As can be seen in the bottom and upper left diagram of FIG. 2B, the first sub-CED duplicates the signal to UE₀ and transmits the duplicated signal at the frequency used by the radio network node 400 to transmit the signal for UE₁. Since the first sub-CED 800A only serves UE₀, there is no interference with the signal to UE₁, and the first sub-CED 800A could use the entire available frequency spectrum to transmit the signal to UE₀. In the current example, the second sub-CED 800B does not spread the signal across frequency, it could however do so if desired since the second sub-CED 800B does only serve UE₁. As can be seen in the bottom and upper left diagram of FIG. 2B it is not possible to send the wideband signal y₀(f) of the upper left diagram, such as the signal transmitted over a wider frequency band, directly from the radio network node 400 to the CED as this would interfere with the signal transmitted by the radio network node 400 and intended for UE₁. For None-Line-of-Sight (NLOS) conditions, where the signaling path may be obstructed by obstacles, which may typically occur between the CED 800 and WDs, transmitting the signal over a wide frequency bandwidth increases the diversity, such as the frequency diversity, of the signal which improves the robustness of the signal, reduces the latency of the signal and/or increases the throughput. The diversity of the signal can herein be seen as the wireless communication system's diversity order at the receiver, such as at a receiver node. In other words, increasing the diversity of the signal at the CED can be seen as the diversity order at the receiver node receiving the retransmitted signal from the CED being higher than the diversity order at the CED when receiving the signal from a transmitter node, such as from a source node of the originally transmitted signal. Correspondingly, for Uplink (UL) transmissions, such as for signals transmitted from any one of the WDs to the radio network node 400, the CED 800 can be configured to narrow the frequency bandwidth over which the signal is transmitted from the CED 800 to the radio network node 400. In other words, by configuring the CED 800 to adjust the frequency width of the signal, an increased diversity, such as an increased frequency diversity, can be created in the links where a high diversity is beneficial, such as between the CED 800 and the WDs. Further, a wideband signal can be transmitted to the WDs while transmitting narrowband signals between the radio network node 400 and the CED 800. Frequency diversity can herein be seen as using two or more spaced frequency channels to send the same signal at the same time. Thereby, channel propagation and interference issues will not affect all frequencies to the same extent, so that at least one signal will be received with acceptable quality, such as with an acceptable Signal-to-Noise Ratio (SNR). Acceptable SNR can herein be seen as an SNR being equal to or above an SNR threshold. In one or more example methods according to this disclosure, a broadening of the frequency width of the retransmitted signal from the CED can be used to increase efficiency of resource allocation for reference signaling.

Assuming LOS propagation between the radio network node 400 and the CED 800, an optimal frequency bandwidth to use for communication between the radio network node 400 and the WD 300 (via the CED 800) boils down to the problem of identifying an optimal frequency band, such as the frequency bandwidth having the highest gain, between the CED and the WDs. According to legacy solutions, the radio network node would send pilot signals, such as Channel State Information Reference Signal (CSI-RS) and/or Synchronization Signal Blocks (SSBs), to the WD in all available frequency bands. The WD 300 may then report Reference Signal Received Power (RSRP) of the CSI-RS/SSB per frequency band. However, by configuring the CED 800 to adjust the frequency width of the retransmitted signal according to the current disclosure, such as the retransmitted CSI-RS/SSB, it is sufficient for the radio network node 400 to transmit the reference signals in a single frequency band. The CED 800 can then broaden the transmission of the reference signal into all available frequency bands upon retransmitting the reference signal to the WD 300. This allows the WD 300 to measure on reference signals in all available frequency bands to determine the optimal frequency bandwidth for the communication between the WD 300 and the radio network node 400, while resources can be freed up at the radio network node 400 for communication, such as communication of data, such as for data transmission and/or data reception.

In one or more example methods, the adjustment of the frequency width, such as a spectral widening, such as the broadening of the frequency bandwidth of the retransmitted signal may be achieved by applying different frequency offsets for different antenna elements of the CED 800 that retransmits the signal. In one or more example methods, to broaden the frequency bandwidth for the impinging signal by for example a factor L, L different frequency offsets can be applied at the CED 800. The number of antenna elements of the CED 800 equipped with a given frequency offset determines the amount of power transmitted in the corresponding frequency. In one or more example methods, the frequency offset can be a frequency offset from the received signal at the CED 800, and/or from a center frequency f_{c} of the frequency spectrum. Hence, in one or more example methods, the transmit power of the signal in each frequency can be adjusted by changing the number of antenna elements transmitting at each frequency.

In one or more example methods, the CED 800 can perform a spectral widening, such as widening of the frequency spectrum, and allocate different spatial footprint to each sub-carrier component. The WD may perform single measurements, such as snapshot measurements, on the different sub-carrier components f₁, . . . , f_{N}. The strongest measurement result may indicate the best beam. Thereby, instant beam selection at the WD may be achieved, without having to perform a beam sweep over time. A single pilot resource, such as a single frequency resource for pilot signal transmission, can be used by the radio network node 400 to sound, such as perform channel sounding on, multiple beams from the CED 800 and for the WD 300 to identify the best beam for further operation, such as for subsequent communication between the radio network node 400 and the WD 300. The radio network node 400 may for example transmit one pilot signal at subcarrier f₀ toward the CED 800. The CED 800 may be configured, for example by the CED controlling node, to broaden the pilot signal transmission into N subcarriers, where a first subcarrier f₁ is redirected toward a direction do, subcarrier f₂ is directed toward direction d₁, and so on. A subcarrier can herein be seen as a bandwidth part, such as a part of the frequency spectrum. The WD may measure on the pilot signals of the respective subcarriers f₁, f₂, . . . , f_{N}. Based on this, the WD (and/or the radio network node) can determine which directions (and hence antenna configuration at the CED) that works best for the communication with the WD and/or the radio network node.

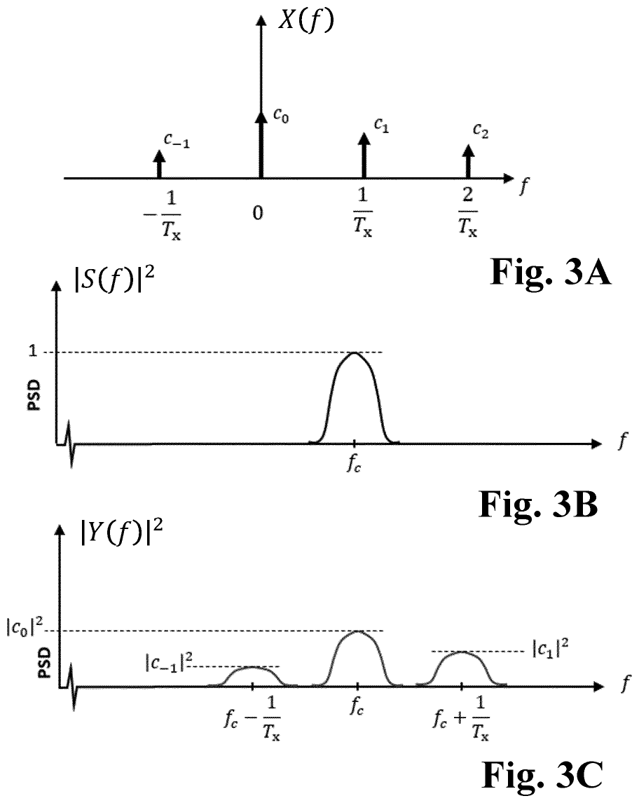

In one or more example methods, each antenna element of the CED 800 may be configured to perform the same operation. In one or more examples, a baseband signal encoded into s(t) is formed by the following linear modulation:

$$s ( t ) = {\sum }_{k = - ∞}^{∞} {a}_{k} p ( t - kT ) \qquad ( Equation 1 )$$

where aₖ are data samples representing an information sequence, T is the symbol time, and p(t) is a baseband waveform. This model can represent all forms of modulations, including Orthogonal Frequency Division Multiplexing (OFDM) systems. If W is a measure of the bandwidth of a signal, such as a one-sided baseband bandwidth of the signal s(t), it follows from well-established modulation theory that W≥1/(2T). In practical implementations however, the bound is typically rather tight, so that the one-sided bandwidth W≈1/(2T). Let x(t) be an arbitrary complex-valued periodic signal with a period Tₓ. Such a signal admits a Fourier series decomposition {cₙ} with coefficients spaced by a frequency 1/Tₓ, such as by a frequency offset 1/Tₓ. Let y(t)=s(t) x(t). In the Fourier plane, such as after the signal has been Fourier transformed, the signal Y(f) can be represented as:

$$Y ( f ) = S ( f ) * X ( f ) = {\sum }_{n = - ∞}^{∞} S ( f - \frac{n}{{T}_{x}} ) {c}_{n} . \qquad ( Equation 2 )$$

where Y(f), S(f), X(f) are the Fourier transforms of y(t), s(t), x(t), respectively. This is illustrated in FIG. 3A-3C, where FIG. 3A shows the Fourier series representation of x(t), and FIG. 3B shows a Power Spectral Density (PSD) of the signal s(t). FIG. 3C shows how the retransmitted PSD from the CED has been broadened in frequency, such as by duplicating the signal and retransmitting them with a frequency offset, such as frequency spacing, 1/Tₓ. However, in FIG. 3C the effect of c₂ in FIG. 3A on the retransmitted signal is not shown. In one or more example methods, the frequency offset 1/Tₓ>2W, since this allows the duplicated signals, such as the replicas of the signal S(f), to be non-interfering. Thereby the WD receives multiple duplications, such as replicas, of the signal, each duplication experiencing a different channel, such as frequency range. The duplicated signals being non-interfering is beneficial for diversity purposes. However, since the bandwidth W≈1/(2T), in one or more example methods the period Tₓ is selected such that it is smaller than the symbol time T, such that Tₓ<T.

In one or more example methods, the solution according to the current disclosure can be implemented by selecting a Tₓ-periodic signal x(t) and letting each antenna element of the CED multiply the signal s(t) to be retransmitted with the signal x(t). In one or more example methods, a spatial beamformer is applied to the signal s(t) in addition to the multiplication with the signal x(t). In one or more example methods, x(t) is selected such that |x(t)|=1. Thereby, only phase changes, such as rapidly changing phase changes, are applied at each antenna. Only applying phase changes can herein be seen as applying phase changes without amplification of the signal. Rapidly changing phase changes can herein be seen as the phase changing at a rate of m/Tₓ, where m is the number of duplicated signals having a transmit power cₙ coefficients essentially nonzero. Being essentially non-zero can herein be seen as having a normalized transmit power |cₙ|² equal to or above a normalized transmit power threshold. The normalized transmit power threshold may in one or more example methods, be in the range of 1-5% of the total transmit power.

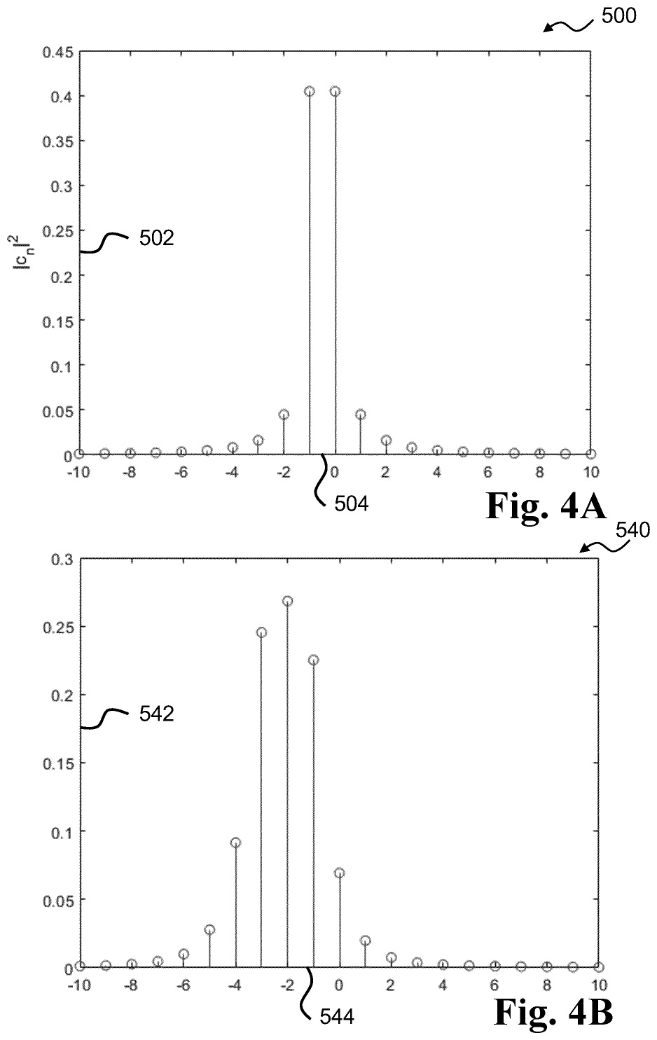

FIG. 4A illustrates the Fourier representation of the signal s(t) multiplied with an example Tₓ-periodic signal x(t) according to one or more example methods according to this disclosure. In the example shown in FIG. 4A, the signal x(t) is selected as x(t)=exp (jπt/Tₓ) for 0≤t≤Tₓ, which gives the Fourier series decomposition of the signal according to FIG. 4A. The axis 504 indicates a normalized frequency, such as the frequency in equidistant distances, such as equidistant frequency offsets, from a center frequency, where the center frequency is indicated as frequency 0. The integers n on axis 504 indicate multiples of an offset frequency. The axis 502 indicates a normalized total transmit power for the duplicated signals transmitted on each of the offset frequencies, where the transmit power of all duplicated signals equates to 1. The distance may be the frequency offset 1/Tₓ. The numbers −2, −1, 1, 2 etc., indicate an integer frequency offset from the center frequency 0. As can be seen in FIG. 4A this results in a Fourier series having two main lobes, such as two local maxima, such as the lobes at 0 and −1. In other words, when the retransmitted signal is duplicated by multiplying it with the signal x(t), the frequency bandwidth of the signal retransmitted by the CED is twice as large (plus a few sidelobes) as the signal s(t) received by the CED. At n=0 the normalized transmit power |c₀|²=0.4. This can be seen as 40% of an incoming signal energy will remain at the frequency in which it was received when the signal is retransmitted by the CED. At n=−1 the normalized transmit power|c₋₁|²=0.4. This can be seen as 40% of the incoming signal energy will be retransmitted with a frequency offset of −1/Tₓ. At n=1 and n=−2, the normalized transmit power |c₁|²=0.05. This can be seen as 5% of the energy will be retransmitted with a respective frequency offset of 1/Tₓ and −2/Tₓ.

FIG. 4B illustrates the Fourier representation of the signal s(t) multiplied with an example Tₓ-periodic signal x(t) according to one or more example methods according to this

$$x ( t ) = exp ( {j ( \frac{nt}{{T}_{x}} )}^{2} ( \frac{29}{20} ) )$$

for 0≤t≤Tₓ, which gives the Fourier series decomposition according to FIG. 4B. The axis 544 indicates the frequency in equidistant distances, such as equidistant frequency offsets, from the center frequency 0. The axis 542 indicates a normalized total transmit power for the signals, where the transmit power of all duplicated signals equates to 1. As can be seen in FIG. 4B this results in a Fourier series having three main lobes, such as three local maxima, such as the lobes at −1, −2 and −3 times the frequency offset from the center frequency. In other words, when the retransmitted signal is duplicated by multiplying it with the signal x(t), the frequency bandwidth of the signal retransmitted by the CED is three times as large (plus a few sidelobes) as the signal s(t) received by the CED. The signals x(t) disclosed in relation to FIGS. 4A and 4B are example Tₓ-periodic signals. However, other Tₓ-periodic signal could also be used for duplicating the signal. The methods disclosed herein are thus not limited to the example Tₓ-periodic signals disclosed in relation to FIGS. 4A and 4B.

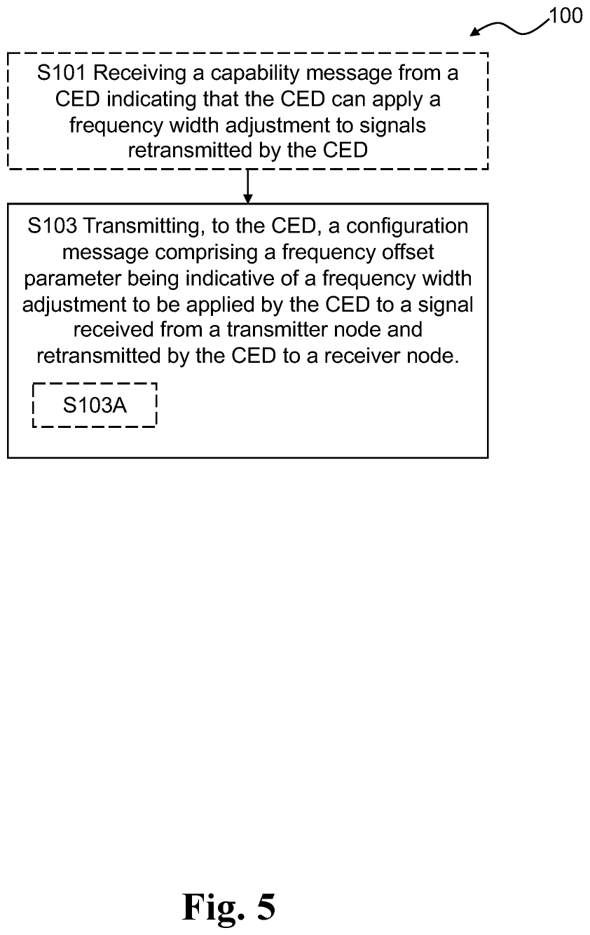

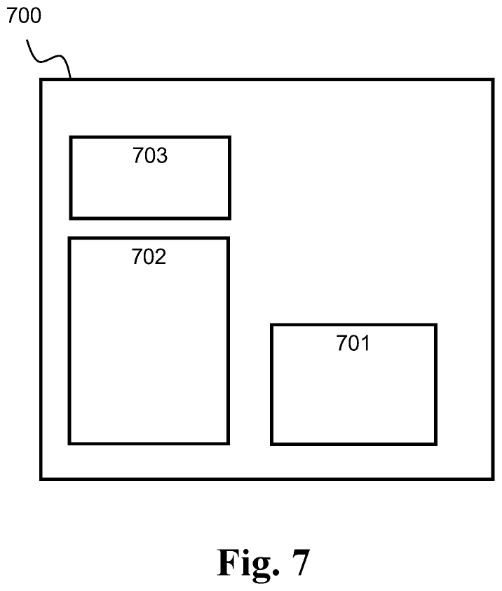

FIG. 5 shows a flow-chart of an example method 100, performed by a coverage enhancing device, CED, controlling node, for controlling a CED. The CED controlling node is the CED controlling node disclosed herein, such as CED controlling node 700 of FIG. 7, such as the radio network node 400 or the WD 300 of FIG. 1 and FIG. 2.

In one or more example methods, the method 100 comprises receiving S101, from the CED, a capability message indicating that the CED can apply a frequency width adjustment to the signal retransmitted by the CED. In one or more example methods, the capability message comprises an indication of a frequency bandwidth supported by the CED.

The method 100 comprises transmitting S103, to the CED, a configuration message comprising a frequency width parameter. The frequency width parameter is indicative of a frequency width adjustment, such as a frequency width reduction or a frequency width broadening, to be applied by the CED to a signal retransmitted by the CED. In one or more example methods herein, a frequency width adjustment can be seen as a duplication of the signal being retransmitted by the CED over a wider frequency range, such as the duplications being transmitted with a respective frequency offset from the frequency of the signal received by the CED. In one or more example methods, a frequency width adjustment does not imply a change of the size of resource elements, such as symbols or subcarrier spacing. The broadening of the frequency width may be dictated by the available frequency spectrum, and/or by how fast the CED can change a phase and/or an amplitude of its antenna elements. In one or more example methods, the total bandwidth of the broadened signal may be limited to a fraction of a carrier frequency f_{c}.

In one or more example methods, the configuration message indicates that a frequency width reduction is to be applied to a signal being retransmitted by the CED, such as a signal transmitted from a WD to a radio network node via the CED. Thereby, a signal can be transmitted over a wider frequency bandwidth between, for example, the CED and the WD than between the radio network node and the CED. The CED may then transmit the signal over a narrower band of the signal, when retransmitting the signal to the radio network node. Thereby, the bandwidth resources, such as frequency resources, can be freed up in the communication between the radio network node and the CED. This can be beneficial since bandwidth resources, such as frequency resources, are typically scarce and channel conditions are typically good between the radio network node and the CED. In one or more example methods, the configuration message indicates that a frequency width broadening is to be applied to a signal being retransmitted by the CED, such as a signal transmitted from a radio network node to a WD via the CED. Thereby, the signal can be transmitted over a narrow frequency bandwidth between the CED and the radio network node to free up frequency resources. The CED may then broaden the bandwidth of the signal: This may for example be done by the CED transmitting the signal, such as duplications of the signal, over a wider frequency bandwidth when retransmitting the signal to the WD.

In one or more example methods, the retransmitted signal is a signal received from a transmitter node and retransmitted by the CED to a receiver node, such as one or more receiver node(s). In one or more example methods, such as when the signal is transmitted in an Uplink (UL), the transmitter node is a WD, such as the WD 300, and the receiver node is a radio network node, such as the radio network node 400. In one or more example methods, such as when the signal is transmitted in a Downlink (DL), the transmitter node is a radio network node, such as the radio network node 400, and the receiver node is a WD, such as the WD 300.

In one or more example methods, transmitting S103 comprises transmitting S103A the configuration message to a receiver node. By transmitting the configuration message to the receiver node, the receiver node can be made aware of when the properties, such as the frequency width, of the received signal will change. The receiver node can be configured to, for example, monitor for signals, such as pilot signals, over the adjusted frequency band. In one or more example methods, the configuration message can be transmitted to the receiver node via the CED.

In one or more example methods, the frequency width parameter is indicative of one or more duplications of the signal, such as a signal s(t), received from the transmitter node over a second frequency range. In one or more example methods, the second frequency range is different than a first frequency range of the signal received from the transmitter node. In one or more example methods, the second frequency range is broader than the first frequency range of the signal received from the transmitter node. The second frequency range may be offset from and/or may overlap with the first frequency range. In one or more example methods, the frequency width parameter is indicative of a number of the one or more duplications to be applied to the signal received from the transmitter node.

In one or more example methods, the frequency width parameter is indicative of the number of the one or more duplications to be applied to the signal received from the transmitter node and the transmit power to be applied to the one or more duplications to be applied to the signal received from the transmitter node. The number of the one or more duplications is indicative of how many times the signal should be duplicated, such as how many different frequency offsets the signal is to be retransmitted with. The frequency width parameter may for example indicate that the signal is to be duplicated m times and/or that the m duplications are to be transmitted with a preconfigured frequency offset from each other.

In one or more example methods, the frequency width parameter is indicative of a transmit power to be applied to the one or more duplications to be applied to the signal received from the transmitter node. In one or more example methods, a respective transmit power can be applied to each of the duplications of the signal.

In one or more example methods, the frequency width parameter, and/or the configuration message, is indicative of a frequency offset of the one or more duplications, such as a frequency offset from a center frequency of the signal received from the transmitter node. The frequency offset may be the frequency offset 1/Tₓ. The frequency offset may indicate the distance between each of the duplications of the signal in the frequency spectrum.

In one or more example methods, the frequency offset may be a preconfigured frequency offset. For example, the CED may be preconfigured with a first frequency offset for UL transmission and a second frequency offset for DL transmission of the retransmitted signal. The first frequency offset and/or the second frequency offset can does be applied by the CED without having to be signaled in the configuration message.

In one or more example methods, the frequency width parameter is indicative of the number of the one or more duplications to be applied to the signal received from the transmitter node and the frequency offset of the one or more duplications from a center frequency of the signal received from the transmitter node. In one or more example methods, the frequency width parameter is indicative of the transmit power to be applied to the one or more duplications and the frequency offset of the one or more duplications from a center frequency of the signal received from the transmitter node.

In one or more example methods, the frequency width parameter is indicative of the number of the one or more duplications to be applied to the signal received from the transmitter node, the transmit power to be applied to the one or more duplications to be applied to the signal received from the transmitter node, and the frequency offset of the one or more duplications from a center frequency of the signal received from the transmitter node.

In one or more example methods, the frequency width parameter is indicative of the second frequency range in which the one or more duplications are to be distributed. In one or more example methods, the second frequency range is indicated as one or more of: an absolute frequency range, a number of subcarriers, a number of resource blocks, and a number of resource elements.

In one or more example methods, the frequency width parameter is indicative of one or more antenna element frequency offsets. In one or more example methods, each of the one or more antenna element frequency offsets is to be applied to a respective set of antenna elements of the CED upon retransmitting the signal to the receiver node. The set of antenna elements may comprise one or more antenna elements. By indicating the frequency offset, such as the frequency offset from the centre frequency, that is to be applied to the respective antenna elements of the CED. Thereby, the transmit power for each duplication of the signal transmitted with a respective dedicated frequency offset can be adapted. The transmit power for each duplication of the signal can for example be increased by increasing the number of antenna elements configured to apply the respective frequency offset of each duplication.

In one or more example methods, the frequency width parameter corresponds to X(f) of Equation 2.

In one or more example methods, the configuration message comprises a duration parameter. The duration parameter may be indicative of a duration, such as a time duration, during which the frequency width adjustment is to be applied to the signal retransmitted by the CED. In one or more example methods, the duration is indicated as a number of symbols. In one or more example methods, the duration is indicated as a number of slots. In one or more example methods, the duration is indicated as the number of symbols and the number of slots. In one or more example methods, the duration parameter is indicative of a start time at which the frequency offset is to be applied. In one or more example methods, the duration parameter is indicative of a stop time at which the frequency offset is not to be applied. The stop time may indicate a time to the CED at which the CED is to refrain from applying the frequency offset to signals retransmitted from the CED. The CED refraining from applying the frequency offset can herein be seen as the CED retransmitting the signal in the same frequency range as the signal was received without transmitting duplications of the signal.

In one or more example methods, the configuration message comprises a pattern indicator indicating a pattern in which the frequency width adjustment is to be applied. In one or more example methods, the pattern indicator indicates that the frequency width adjustment is to be applied to uplink and/or downlink signaling.

In one or more example methods, the configuration message comprises a spatial direction indicator indicating a spatial direction in which the frequency width adjustment is to be applied. In one or more example methods, the pattern indicator indicates that the CED is to apply the frequency width adjustment in certain input and/or output directions only. The spatial direction indicator may be indicative of the certain input and/or output directions.

In one or more example methods, it may be hardcoded into the system, such as preconfigured in the CED, the transmitter node and/or the receiver node, that a frequency width adjustment is to be applied to uplink, to downlink, and/or to both uplink and downlink.

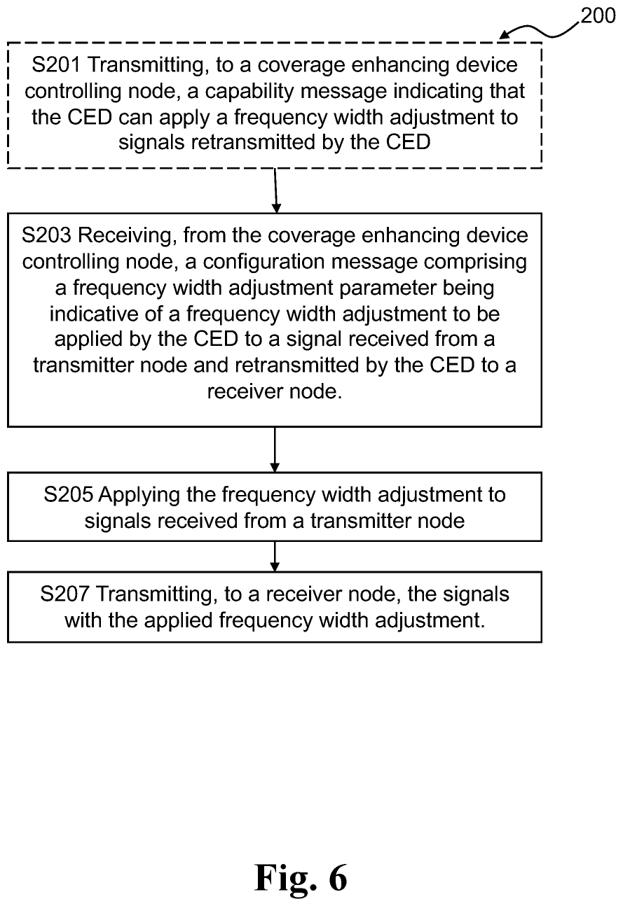

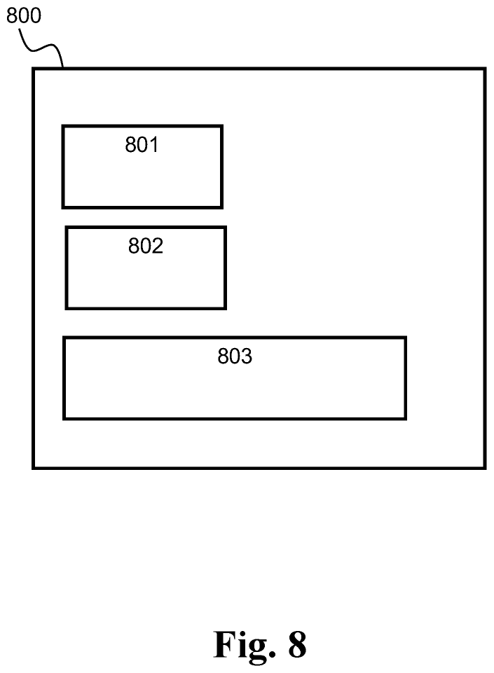

FIG. 6 shows a flow diagram of an example method 200, performed by a coverage enhancing device, CED. The method may be a method for retransmission of a signal received by the CED. The CED is the CED disclosed herein, such as CED 800 of FIG. 1, FIG. 2, and FIG. 8.

In one or more example methods, the method 200 comprises transmitting S201, to the CED controlling node, a capability message indicating that the CED can apply a frequency width adjustment to signals retransmitted by the CED. In one or more example methods, the capability message comprises an indication of a frequency bandwidth supported by the CED. The frequency bandwidth supported by the CED may be indicative of the frequency range within which the CED can apply the frequency offset.

The method 200 comprises receiving S203, from a CED controlling node, a configuration message. The configuration message comprises a frequency width parameter. The frequency width parameter is indicative of a frequency width adjustment, such as a frequency width reduction or a frequency width broadening, to be applied by the CED to a signal retransmitted by the CED. In one or more example methods, the configuration message indicates that a frequency width reduction is to be applied to a signal being retransmitted by the CED, such as a signal transmitted from a WD to a radio network node via the CED. Thereby, a signal can be transmitted over a wider frequency bandwidth between for example the CED and the WD than between the radio network node and the CED. The CED may then reduce the bandwidth and transmit the signal over a narrower band of the signal, when retransmitting the signal to the radio network node. Thereby, the bandwidth resources, such as frequency resources, can be freed up in the communication between the radio network node and the CED, where bandwidth resources are typically scarce, and channel conditions are typically good. In one or more example methods, the configuration message indicates that a frequency width broadening is to be applied to a signal being retransmitted by the CED, such as a signal transmitted from a radio network node to a WD via the CED. Thereby, the signal can be transmitted over a narrow frequency bandwidth between the CED and the radio network node to free up frequency resources. The CED may then broaden the bandwidth of the signal, such as transmit the signal, such as duplications of the signal over a wider frequency bandwidth when retransmitting the signal to the WD.

In one or more example methods, the configuration message is received via Radio Resource Control (RRC) signaling.

In one or more example methods, the retransmitted signal is a signal received from a transmitter node and retransmitted by the CED to a receiver node. In one or more example methods, such as when the signal is transmitted in an Uplink (UL), the transmitter node is a WD, such as the WD 300, and the receiver node is a radio network node, such as the radio network node 400. In one or more example methods, such as when the signal is transmitted in a Downlink (DL), the transmitter node is a radio network node, such as the radio network node 400, and the receiver node is a WD, such as the WD 300.

In one or more example methods, the frequency width parameter is indicative of one or more duplications of the signal received from the transmitter node over a second frequency range. In other words, the signal can be received from the transmitter node over a first frequency range and the frequency width parameter indicates one or more duplications of the signal to be transmitted by the CED over a second frequency range to a receiver node. In one or more example methods, the second frequency range is different than a first frequency range of the signal received from the transmitter node. In one or more example methods, the second frequency range is broader than the first frequency range of the signal received from the transmitter node. In one or more example methods, the frequency width parameter is indicative of a number of the one or more duplications to be applied to the signal received from the transmitter node.

In one or more example methods, the frequency width parameter is indicative of a number of the one or more duplications to be applied to the signal received from the transmitter node. In one or more example methods, the frequency width parameter is indicative of a transmit power to be applied to the one or more duplications to be applied to the signal received from the transmitter node. In one or more example methods, the frequency width parameter is indicative of a frequency offset of the one or more duplication from a center frequency of the signal received from the transmitter node. In one or more example methods, the frequency width parameter is indicative of the number of the one or more duplications to be applied to the signal received from the transmitter node and the transmit power to be applied to the one or more duplications to be applied to the signal received from the transmitter node. In one or more example methods, the frequency width parameter is indicative of the number of the one or more duplications to be applied to the signal received from the transmitter node and the frequency offset of the one or more duplication from a center frequency of the signal received from the transmitter node. In one or more example methods, the frequency width parameter is indicative of the transmit power to be applied to the one or more duplications to be applied to the signal received from the transmitter node and the frequency offset of the one or more duplication from a center frequency of the signal received from the transmitter node. In one or more example methods, the frequency width parameter is indicative of the number of the one or more duplications to be applied to the signal received from the transmitter node, the transmit power to be applied to the one or more duplications to be applied to the signal received from the transmitter node, and the frequency offset of the one or more duplication from a center frequency of the signal received from the transmitter node.

In one or more example methods, the frequency width parameter is indicative of the second frequency range in which the one or more duplications are to be distributed. The second frequency range may be indicated as one or more of an absolute frequency range, a number of subcarriers, a number of resource blocks, and a number of resource elements.

In one or more example methods, the frequency width parameter is indicative of one or more antenna element frequency offsets. In one or more example methods, each of the one or more antenna element frequency offsets is to be applied to a respective set of antenna elements of the CED upon retransmitting the signal to the receiver node. By indicating the frequency offset, such as the frequency offset from the center frequency, that is to be applied to the respective antenna elements of the CED. Thereby, the transmit power for each duplication of the signal transmitted with a respective dedicated frequency offset can be adapted. The transmit power for each duplication of the signal can for example be increased by increasing the number of antenna elements configured to apply the respective frequency offset of each duplication.

In one or more example methods, the frequency width parameter corresponds to X(f) of Equation 2.

In one or more example methods, the configuration message comprises a duration parameter. The duration parameter may be indicative of a duration during which the frequency offset is to be applied to the signals retransmitted by the CED. In one or more example methods, the duration is indicated as a number of symbols. In one or more examples, the duration is indicated as a number of slots. In one or more example methods, the duration is indicated as the number of symbols and the number of slots. In one or more example methods, the duration parameter is indicative of a start time at which the frequency offset is to be applied.

In one or more example methods, the configuration message comprises a pattern indicator indicating a pattern in which the frequency offset is to be applied. In one or more example methods, the pattern indicator indicates that the frequency width adjustment is to be applied to uplink and/or downlink signaling.

In one or more example methods, it may be hardcoded into the system, such as preconfigured in the CED, the transmitter node and/or the receiver node, that a frequency width adjustment is to be applied to uplink, to downlink, and/or to both uplink and downlink.

The method 200 comprises applying S205 the frequency width adjustment to a signal, such as to the signal S(f), received from a transmitter node. In one or more example methods, applying S205 the frequency width adjustment to the signal comprises duplicating the signal according to the frequency width parameter. In one or more example methods, applying the frequency width adjustment to the signal comprises allocating the duplicated signals with a frequency offset based on the frequency width parameter. In one or more example methods, applying the frequency width adjustment to the signal comprises multiplying the signal with the frequency width parameter, such as with the X(f) in accordance with Equation 2. The signal can, in one or more example methods, be multiplied with the frequency width parameter, such as with X(f) in accordance with Equation 2, to generate one or more duplications of the signal. The one or more duplications of the signal can be configured to be transmitted by the CED with a frequency offset to each other.

The method 200 comprises transmitting S207, to a receiver node, the signal with the applied frequency width adjustment. In one or more example methods, transmitting S207 the signal comprises transmitting the signal, such as the duplicated signal, over an adjusted frequency bandwidth compared to the frequency bandwidth of the signal received by the CED, in accordance with the frequency width parameter.

FIG. 7 shows a block diagram of an example CED controlling node 700 according to the disclosure. The CED controlling node 700 comprises memory circuitry 701, processor circuitry 702, and a wireless interface 703. The CED controlling node 700 may be configured to perform any of the methods disclosed in FIG. 5. In other words, the CED controlling node 700 may be configured for controlling a CED.

The CED controlling node 700 is configured to communicate with a CED, such as the CED disclosed herein, using a wireless communication system.

The wireless interface 703 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands, such as NTN and/or sidelink communication.

The CED controlling node 700 is configured to transmit, for example, via the wireless interface 703, to the CED, a configuration message. The configuration message comprises a frequency width parameter. The frequency width parameter is indicative of a frequency width adjustment to be applied by the CED to a signal retransmitted by the CED.

Processor circuitry 702 is optionally configured to perform any of the operations disclosed in FIG. 5 (such as any one or more of S101, S103). The operations of the CED controlling node 700 may be embodied in the form of executable logic routines (for example, lines of code, software programs, etc.) that are stored on a non-transitory computer readable medium (for example, memory circuitry 701) and are executed by processor circuitry 702.

Furthermore, the operations of the CED controlling node 700 may be considered a method that the CED controlling node 700 is configured to carry out. Also, while the described functions and operations may be implemented in software, such functionality may also be carried out via dedicated hardware or firmware, or some combination of hardware, firmware and/or software.

Memory circuitry 701 may be one or more of a buffer, a flash memory, a hard drive, a removable media, a volatile memory, a non-volatile memory, a random access memory (RAM), or other suitable device. In a typical arrangement, memory circuitry 701 may include a non-volatile memory for long term data storage and a volatile memory that functions as system memory for processor circuitry 702. Memory circuitry 701 may exchange data with processor circuitry 702 over a data bus. Control lines and an address bus between memory circuitry 701 and processor circuitry 702 also may be present (not shown in FIG. 7). Memory circuitry 701 is considered a non-transitory computer readable medium.

Memory circuitry 701 may be configured to store the frequency width parameter, a duration parameter, and a pattern indicator in a part of the memory.

FIG. 8 shows a block diagram of an example CED 800 according to the disclosure. The CED 800 comprises memory circuitry 801, processor circuitry 802, and a wireless interface 803. The CED 800 may be configured to perform any of the methods disclosed in FIG. 6.

The CED 800 is configured to communicate with a CED controlling node, such as the CED controlling node disclosed herein, using a wireless communication system.

The wireless interface 803 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands, such as NTN and/or sidelink communication.

The CED 800 is configured to receive, for example, via the wireless interface 803, from the CED controlling node, a configuration message. The configuration message comprises a frequency width parameter. The frequency width parameter is indicative of a frequency width adjustment to be applied by the CED to a signal retransmitted by the CED.

The CED 800 is configured to apply, for example, via the wireless interface 803, the frequency width adjustment to a signal received from a transmitter node.

The CED 800 is configured to transmit, for example, via the wireless interface 803, to a receiver node, the signal with the applied frequency width adjustment.

Processor circuitry 802 is optionally configured to perform any of the operations disclosed in FIG. 6 (such as any one or more of S201, S203, S205, S207). The operations of the CED 800 may be embodied in the form of executable logic routines (for example, lines of code, software programs, etc.) that are stored on a non-transitory computer readable medium (for example, memory circuitry 801) and are executed by processor circuitry 802.

Furthermore, the operations of the CED 800 may be considered a method that the CED 800 is configured to carry out. Also, while the described functions and operations may be implemented in software, such functionality may also be carried out via dedicated hardware or firmware, or some combination of hardware, firmware and/or software.

Memory circuitry 801 may be one or more of a buffer, a flash memory, a hard drive, a removable media, a volatile memory, a non-volatile memory, a random access memory (RAM), or other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 8). Memory circuitry 801 is considered a non-transitory computer readable medium.

Memory circuitry 801 may be configured to store the frequency width parameter, a duration parameter, and a pattern indicator in a part of the memory in a part of the memory.

Examples of methods and products (CED controlling node and CED) according to the disclosure are set out in the following items:
Item 1. A method performed by a coverage enhancing device, CED, controlling node, for controlling a CED, the method comprising:
   transmitting (S103), to the CED, a configuration message, the configuration message comprising a frequency width parameter, wherein the frequency width parameter is indicative of a frequency width adjustment to be applied by the CED to a signal retransmitted by the CED.
Item 2. The method according to Item 1, wherein the retransmitted signal is a signal received from a transmitter node and retransmitted by the CED to a receiver node, the frequency width parameter being indicative of one or more duplications of the signal received from the transmitter node over a second frequency range, the second frequency range being broader than a first frequency range of the signal received from the transmitter node.
Item 3. The method according to Item 2, wherein the frequency width parameter is indicative of one or more of:
   a number of the one or more duplications to be applied to the signal received from the transmitter node,
   a transmit power to be applied to the one or more duplications to be applied to the signal received from the transmitter node, and
   a frequency offset of the one or more duplications from a centre frequency of the signal received from the transmitter node.
Item 4. The method according to Item 2 or 3, wherein the frequency width parameter is indicative of the second frequency range in which the one or more duplications are to be distributed.
Item 5. The method according to Item 4, wherein the second frequency range is indicated as one or more of:
   an absolute frequency range,
   a number of subcarriers,
   a number of resource blocks, and
   a number of resource elements.
Item 6. The method according to Item 1, wherein the frequency width parameter is indicative of one or more antenna element frequency offsets, wherein each of the one or more antenna element frequency offsets is to be applied to a respective set of antenna elements of the CED upon retransmitting the signal to the receiver node.
Item 7. The method according to any one of the previous Items, wherein the configuration message comprises a duration parameter being indicative of a duration during which the frequency width adjustment is to be applied to the signal retransmitted by the CED.
Item 8. The method according to Item 7, wherein the duration is indicated as one or more of a number of symbols and a number of slots.
Item 9. The method according to Item 7 or 8, wherein the duration parameter is indicative of a start time at which the frequency offset is to be applied.
Item 10. The method according to any one of the previous Items, wherein the configuration message comprises a pattern indicator indicating a pattern in which the frequency width adjustment is to be applied.
Item 11. The method according to Item 10, wherein the pattern indicator indicates that the frequency width adjustment is to be applied to uplink and/or downlink signaling.
Item 12. The method according to any one of the previous Items, wherein the method comprises:
   receiving (S101), from the CED, a capability message indicating that the CED can apply a frequency width adjustment to the signal retransmitted by the CED.
Item 13. The method according to Item 12, wherein the capability message comprises an indication of a frequency bandwidth supported by the CED.
Item 14. A method, performed by a coverage enhancing device, CED, the method comprising:
   receiving (S203), from a CED controlling node, a configuration message, wherein the configuration message comprises a frequency width parameter, the frequency width parameter being indicative of a frequency width adjustment to be applied by the CED to a signal retransmitted by the CED,
   applying (S205) the frequency width adjustment to a signal received from a transmitter node, and
   transmitting (S207), to a receiver node, the signal with the applied frequency width adjustment.
Item 15. The method according to Item 14, wherein the retransmitted signal is a signal received from a transmitter node and retransmitted by the CED to a receiver node, the frequency width parameter being indicative of one or more duplications of the signal received from the transmitter node over a second frequency range, the second frequency range being broader than a first frequency range of the signal received from the transmitter node.
Item 16. The method according to Item 15, wherein the frequency width parameter is indicative of one or more of:
   a number of the one or more duplications to be applied to the signal received from the transmitter node,
   a transmit power to be applied to the one or more duplications to be applied to the signal received from the transmitter node, and
   a frequency offset of the one or more duplication from a centre frequency of the signal received from the transmitter node.
Item 17. The method according to Item 15 or 16, wherein the frequency width parameter is indicative of the second frequency range in which the one or more duplications are to be distributed.
Item 18. The method according to Item 17, wherein the second frequency range is indicated as one or more of:
   an absolute frequency range,
   a number of subcarriers,
   a number of resource blocks, and
   a number of resource elements.
Item 19. The method according to any one of the Items 14-18, wherein the frequency width parameter is indicative of one or more antenna element frequency offsets, wherein each of the one or more antenna element frequency offsets is to be applied to a respective set of antenna elements of the CED upon retransmitting the signal to the receiver node.
Item 20. The method according to any one of the Items 14 to 19, wherein the configuration message comprises a duration parameter being indicative of a duration during which the frequency offset is to be applied to the signals retransmitted by the CED.
Item 21. The method according to Item 20, wherein the duration is indicated as one or more of a number of symbols and a number of slots.
Item 22. The method according to Item 20 or 21, wherein the duration parameter is indicative of a start time at which the frequency offset is to be applied.
Item 23. The method according to any one of the Items 14 to 22, wherein the configuration message comprises a pattern indicator indicating a pattern in which the frequency offset is to be applied.
Item 24. The method according to Item 23, wherein the pattern indicator indicates that the frequency width adjustment is to be applied to uplink and/or downlink signaling.
Item 25. The method according to any one of the Items 14-24, wherein the method comprises:
   transmitting (S201), to the CED controlling node, a capability message indicating that the CED can apply the frequency offset to signals retransmitted by the CED.
Item 26. The method according to Item 25, wherein the capability message comprises an indication of a frequency bandwidth supported by the CED.
Item 27. A coverage enhancing device, CED, controlling node comprising memory circuitry, processor circuitry, and a wireless interface, wherein the CED controlling node is configured to perform any of the methods according to any of Items 1-13.
Item 28. A coverage enhancing device, CED, comprising memory circuitry, processor circuitry, and a wireless interface, wherein the CED is configured to perform any of the methods according to any of Items 14-26.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1 to 8 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a coverage enhancing device (CED), controlling node, for controlling a CED, the method comprising:
transmitting, to the CED, a configuration message, the configuration message comprising a frequency width parameter, wherein the frequency width parameter is indicative of a frequency width adjustment to be applied by the CED to a signal retransmitted by the CED.

2. The method according to claim 1, wherein the retransmitted signal is a signal received from a transmitter node and retransmitted by the CED to a receiver node, the frequency width parameter being indicative of one or more duplications of the signal received from the transmitter node over a second frequency range, the second frequency range being broader than a first frequency range of the signal received from the transmitter node.

3. The method according to claim 2, wherein the frequency width parameter is indicative of one or more of:
a number of the one or more duplications to be applied to the signal received from the transmitter node,
a transmit power to be applied to the one or more duplications to be applied to the signal received from the transmitter node,
a frequency offset of the one or more duplications from a centre frequency of the signal received from the transmitter node, and
the second frequency range in which the one or more duplications are to be distributed.

4. The method according to claim 3, wherein the second frequency range is indicated as one or more of:
an absolute frequency range,
a number of subcarriers,
a number of resource blocks, and
a number of resource elements.

5. The method according to claim 1, wherein the frequency width parameter is indicative of one or more antenna element frequency offsets, wherein each of the one or more antenna element frequency offsets is to be applied to a respective set of antenna elements of the CED upon retransmitting the signal to the receiver node.

6. The method according to claim 1, wherein the configuration message comprises a duration parameter being indicative of a duration during which the frequency width adjustment is to be applied to the signal retransmitted by the CED.

7. The method according to claim 6, wherein the duration is indicated as one or more of a number of symbols and a number of slots.

8. The method according to claim 6, wherein the duration parameter is indicative of a start time at which the frequency offset is to be applied.

9. The method according to claim 1, wherein the configuration message comprises a pattern indicator indicating a pattern in which the frequency width adjustment is to be applied.

10. The method according to claim 9, wherein the pattern indicator indicates that the frequency width adjustment is to be applied to uplink and/or downlink signaling.

11. The method according to claim 1, wherein the method comprises:
receiving, from the CED, a capability message indicating that the CED can apply a frequency width adjustment to the signal retransmitted by the CED.

12. The method according to claim 11, wherein the capability message comprises an indication of a frequency bandwidth supported by the CED.

13. A method, performed by a coverage enhancing device (CED), the method comprising:
receiving, from a CED controlling node, a configuration message, wherein the configuration message comprises a frequency width parameter, the frequency width parameter being indicative of a frequency width adjustment to be applied by the CED to a signal retransmitted by the CED,
applying the frequency width adjustment to a signal received from a transmitter node, and
transmitting, to a receiver node, the signal with the applied frequency width adjustment.

14. The method according to claim 13, wherein the retransmitted signal is a signal received from a transmitter node and retransmitted by the CED to a receiver node, the frequency width parameter being indicative of one or more duplications of the signal received from the transmitter node over a second frequency range, the second frequency range being broader than a first frequency range of the signal received from the transmitter node.

15. The method according to claim 14, wherein the frequency width parameter is indicative of one or more of:
a number of the one or more duplications to be applied to the signal received from the transmitter node,
a transmit power to be applied to the one or more duplications to be applied to the signal received from the transmitter node, and
a frequency offset of the one or more duplication from a centre frequency of the signal received from the transmitter node.

16. The method according to claim 14, wherein the frequency width parameter is indicative of the second frequency range in which the one or more duplications are to be distributed.

17. The method according to claim 16, wherein the second frequency range is indicated as one or more of:
an absolute frequency range,
a number of subcarriers,
a number of resource blocks, and
a number of resource elements.

18. The method according to claim 13, wherein the frequency width parameter is indicative of one or more antenna element frequency offsets, wherein each of the one or more antenna element frequency offsets is to be applied to a respective set of antenna elements of the CED upon retransmitting the signal to the receiver node.

19. The method according to claim 13, wherein the configuration message comprises a duration parameter being indicative of a duration during which the frequency offset is to be applied to the signals retransmitted by the CED.

20. The method according to claim 19, wherein the duration is indicated as one or more of a number of symbols and a number of slots.

21-27. (canceled)
